(19) United States
(12) Patent Application Publication
(10) Pub. No.: US 2010/0138195 A1
(43) Pub. Date: Jun. 3, 2010

(54) ANALYSIS MESH GENERATION APPARATUS

(76) Inventors: Makoto Onodera, Mito (JP); Yoshimitsu Hiro, Yokohama (JP); Ichiro Nishigaki, Ishioka (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/620,891

(22) Filed: Nov. 18, 2009

(30) Foreign Application Priority Data
Nov. 19, 2008 (JP) 2008-295042

(51) Int. Cl. G06F 17/50

(52) U.S. Cl. 703/1

(57) ABSTRACT

The conventional technologies are impractical for the following reason. CAD has been the only solution for changing an analysis model with adding or deleting a fillet. In this case, it is necessary to repeat the mesh generation and condition configuration, which makes the work time longer especially for large-scale or complicated shape data. The present invention, accomplished to solve the above-mentioned problem, provides an analysis mesh generation apparatus including a computer for generating a mesh model. The apparatus is configured to create a screen for selecting an edge of a mesh model and entering a radius of a fillet to be applied to the selected edge; and to create a screen for generating a mesh for the applied fillet, generating a new mesh model by deleting or adding an area enclosed by a contour of the mesh model and the fillet, and displaying the new mesh model.

### CLAIM OF PRIORITY

The present application claims priority from Japanese Patent Application JP 2008-295042 filed on Nov. 19, 2008, the content of which is hereby incorporated by reference into this application.

### FIELD OF THE INVENTION

The present invention relates to a CAE (Computer Aided Engineering) system that numerically simulates physical phenomena based on numerical analysis using a computer. More particularly, the invention relates to generation of analysis models in CAE.

### BACKGROUND OF THE INVENTION

Using the CAE in product development processes reduces development costs and shortens a design and development period. In the CAE, an analysis model is generated from a shape model generated by a CAD (Computer Aided Design) system and is used, for example, for intensity analysis, thermal analysis, or vibration analysis based on analysis methods, such as the finite element method or the boundary element method. The analysis model generation in the CAE requires a large quantity of work such as generation of a mesh model from the shape model and configuration of parameters or boundary conditions for each element of the mesh model.

To reduce the workload for analysis model generation, some technologies have been proposed. For example, Japanese Unexamined Patent Application Publication No. HEI3-70083 discloses a technology of integrating the functions of shape model generation, analysis mesh generation, and model analysis into a single system. Methods of generating a fillet as a function of shape model generation are disclosed in Japanese Unexamined Patent Application Publication Nos. HEI8-137917 and HEI8-153125, and in a book entitled 3D CAD—Basics and Applications, pp. 143-150 (KYORITSU SHUPPAN CO., LTD, 1991).

Japanese Unexamined Patent Application Publication No. 2006-301753 discloses a technology of generating an intended analysis model using an existing analysis model. The technology recognizes geometrical characteristics of the existing analysis model from the element faces of the exterior surface of the model. The technology provides the geometrical characteristics or the relation between the geometrical characteristics with a dimensional value (dimensional constraint) of a transformed shape. The technology transforms the mesh using the geometrical characteristics and the dimensional constraint as restrictions to generate an intended analysis model. The technology is capable of adding or deleting the shape characteristics, such as ribs and holes.

Similarly to Japanese Unexamined Patent Application Publication No. 2006-301753, Japanese Unexamined Patent Application Publication No. 2003-108609 discloses a technology of generating an intended analysis model using an existing analysis model. The technology provides the existing analysis model with corresponding reference points. The technology moves the reference points based on the correlation of the reference points and the mesh data in the existing analysis model. In this manner, the technology transforms the mesh data in the existing analysis model to generate the intended analysis model.

Technologies capable of generating an analysis model from a CAD model that is generated during a design process are disclosed in Japanese Unexamined Patent Application Publication Nos. HEI3-70083, HEI8-137917, and HEI8-153125, and in the book entitled 3D CAD—Basics and Applications. Even when a shape is changed due to a design change or a product model change, the technologies can apply necessary modifications to the CAD model and generate an analysis model from the CAD model.

Technologies capable of changing shapes of an existing analysis model and generating a newly shaped analysis model are disclosed in Japanese Unexamined Patent Application Publication Nos. 2006-301753 and 2003-108609, and in CDAJ NEWS vol. 51, March 2008. The technologies eliminate processes of the generation of meshes and the configuration of conditions for a reshaped CAD model, greatly reducing the workload for analysis model generation.

As mentioned above, CAE is accompanied by the problem of reducing the workload for analysis model generation. To solve this problem, the technology disclosed in Japanese Unexamined Patent Application Publication No. HEI3-70083 can reduce the workload for analysis model generation by integrating the functions of shape model generation, analysis mesh generation, and model analysis into a single system. The technologies disclosed in Japanese Unexamined Patent Application Publication Nos. HEI8-137917 and HEI8-153125, and in the book entitled 3D CAD—Basics and Applications can generate a fillet for the CAD model and generate an analysis model after an additional fillet is generated.

However, these technologies need to reconfigure the mesh generation work and the conditioning work each time the CAD is used to change shapes. Therefore, the technologies are impractical for large-scale and complicated shape data.

The technologies disclosed in Japanese Unexamined Patent Application Publication Nos. 2006-301753 and 2003-108609, and in CDAJ NEWS vol. 51 seem to be more effective for the problem because the technologies generate an intended analysis model using an existing analysis model. The technologies use the existing analysis model to generate an intended analysis model, eliminating processes of the generation of mesh data and the configuration of boundary conditions. Accordingly, the technologies can greatly reduce the workload for the analysis model generation. The technology disclosed in Japanese

Unexamined Patent Application Publication No. 2006-301753 is capable of changing dimension, such as a distance between plane faces of the mesh model or a radius of a cylinder model. However, the technology is incapable of adding or deleting a fillet. The technology disclosed in Japanese Unexamined Patent Application Publication No. 2003-108609, which reshapes the analysis model only by moving nodes, is incapable of adding or deleting a fillet. The technology disclosed in CDAJ NEWS vol. 51 can change a fillet radius by moving mesh nodes of a selected fillet.

Therefore, the conventional technologies are impractical for the following reason. CAD has been the only solution for changing an analysis model with adding or deleting a fillet. In this case, it is necessary to repeat the mesh generation and condition configuration, which makes the work time longer especially for large-scale or complicated shape data.

The object of the present invention is to provide an analysis mesh generation apparatus that can directly delete or add a fillet for an analysis model.

### SUMMARY OF THE INVENTION

The present invention, accomplished to solve the above-mentioned problem, provides an analysis mesh generation apparatus including a computer for generating a mesh model. The apparatus is configured to create a screen for selecting an edge of a mesh model and entering a radius of a fillet to be applied to the selected edge; and to create a screen for generating a mesh for the applied fillet, generating a new mesh model by deleting or adding an area enclosed by a contour of the mesh model and the fillet, and displaying the new mesh model

The present invention also provides an analysis mesh generation apparatus including a computer for generating a mesh model. The apparatus is configured to create a screen for specifying a mesh model; to create a screen for selecting an edge for a fillet to be applied in the specified mesh model; to create a screen for entering a radius of the fillet; and to create a screen for generating a fillet face based on the radius of the fillet, generating a fillet area shape from the fillet face and a face generated by extending an element face adjacent to the edge, generating a new mesh model by deleting or adding a mesh for an area enclosed by the fillet area shape on a contour of the mesh model, and displaying the new mesh model.

Preferably, if the edge is convex, the new mesh model is generated by deleting the mesh for the area enclosed by the contour of the mesh model and the fillet area shape.

Preferably, if the edge is concave, the new mesh model is generated by adding the mesh for the area enclosed by the contour of the mesh model and the fillet area shape.

Preferably, the apparatus is configured to further create a screen for specifying a division count for dividing the fillet face in a circumferential direction of the fillet; and to create a screen for displaying the new mesh model that is obtained by dividing the fillet face in the fillet area shape by the division count.

Preferably, the apparatus is configured to further create a screen for specifying a threshold value for an edge extraction angle between normal lines of adjacent meshes; to create a screen for extracting an edge group that has the edge extraction angle greater than or equal to the threshold value, and displaying the new mesh model that is obtained by adding the extracted edge group to the mesh model; and to create a screen for selecting the edge group that is added to the mesh model.

Preferably, the apparatus is configured to further create a screen for recognizing characteristics of the mesh model for edge extraction; to create a screen for displaying the new mesh model that is obtained by adding a boundary between the characteristics to the mesh model which the characteristics is recognized of; and to create a screen for selecting the boundary between the characteristics in the new mesh model.

The present invention also provides an analysis mesh generation apparatus including a computer for generating a mesh model. The apparatus is configured to create a screen for specifying a mesh model; to create a screen for selecting a fillet face to be deleted from the mesh model; and to create a screen for generating a fillet area shape from the fillet face and a face generated by extending an element face adjacent to the fillet face, generating a new mesh model by deleting or adding a mesh for an area enclosed by the fillet area shape on a contour of the mesh model, and displaying the new mesh model.

Preferably, if the fillet face is convex, the new mesh model is generated by adding the mesh for the area enclosed by the contour of the mesh model and the fillet area shape.

Preferably, if the fillet face is concave, the new mesh model is generated by deleting the mesh for the area enclosed by the contour of the mesh model and the fillet area shape.

Preferably, the apparatus is configured to further create a screen for recognizing characteristics of the mesh model for edge extraction; to create a screen for displaying the new mesh model that is obtained by adding a boundary between the characteristics to the mesh model which the characteristics is recognized of; and to create a screen for selecting and deleting the boundary between the characteristics in the new mesh model.

An analysis mesh generation apparatus according to the present invention, in which a fillet is directly deleted or added for the analysis mesh model, can reduce the number of processes for analysis model generation and the hours of work

### BRIEF DESCRIPTION OF THE DRAWINGS

FIG. 1 shows a block diagram of an analysis mesh generation apparatus in accordance with a first embodiment of the present invention;

FIG. 2 shows an example of a screen of a targeted analysis mesh specification section;

FIG. 3 shows an example of a screen of a fillet information input section during fillet addition;

FIG. 4 shows an example of a screen of the fillet information input section during fillet deletion;

FIG. 5 shows examples of PAD for processes of a fillet area shape generation section;

FIG. 6 shows an example of a process of the fillet area shape generation section during fillet addition;

FIG. 7 shows an example of a process of the fillet area shape generation section during fillet deletion;

FIGS. 8 and 9 show examples of PADs for processes of a fillet mesh addition/deletion section;

FIG. 10 shows an example of a process of the fillet mesh addition/deletion section when a fillet is added to a convex edge;

FIG. 11 shows an example of a process of the fillet mesh addition/deletion section when a fillet is added to a concave edge;

FIG. 12 shows an example of a process of the fillet mesh addition/deletion section when a convex fillet is deleted;

FIG. 13 shows an example of a process of the fillet mesh addition/deletion section when a concave fillet is deleted;

FIG. 14 shows the first example of usage procedure for the analysis mesh generation apparatus of the present invention;

FIG. 15 shows the second example of usage procedure for the analysis mesh generation apparatus of the present invention;

FIG. 16 shows the third example of usage procedure for the analysis mesh generation apparatus of the present invention; and

FIG. 17 shows the forth example of usage procedure for the analysis mesh generation apparatus of the present invention.

### DETAILED DESCRIPTION OF THE PREFERRED EMBODIMENTS

In this specification, “to fillet” means “to add a fillet or fillets” and “to unfillet” means “to delete a fillet or fillets.”

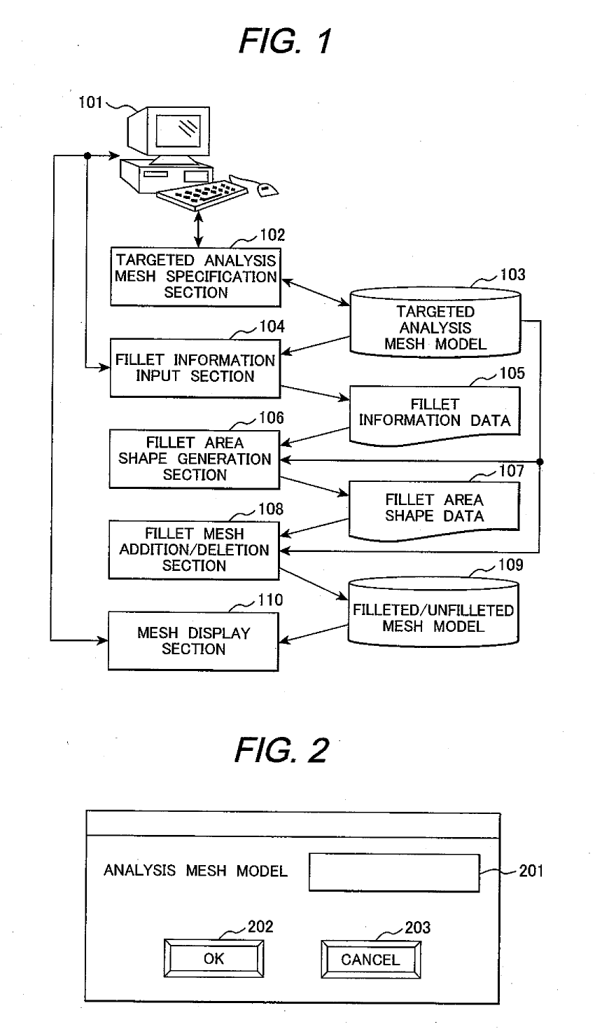

FIG. 1 shows a block diagram of an analysis mesh generation apparatus according to a first embodiment of the present invention.

The analysis mesh generation apparatus includes a computer for generating a mesh mode. The computer includes an input/output device 101, a targeted analysis mesh specification section 102, a fillet information input section 104, a fillet area shape generation section 106, a fillet mesh addition/deletion section 108, and a mesh display section 110.

The input/output device 101 includes devices, such as a keyboard, a pointing device, and a display, for a user of the apparatus to enter and view data. The targeted analysis mesh specification section 102 specifies a targeted analysis mesh model 103. The fillet information input section 104 selects an edge for filleting the mesh model 103, inputs a radius of the fillet applied to the selected edge, and stores the radius as fillet information data 105. The fillet area shape generation section 106 generates a fillet face based on the fillet information data 105, and generates fillet area shape data 107 from the fillet face and a face that is generated by extending an adjacent element face of the selected edge. The fillet mesh addition/deletion section 108 generates a filleted mesh model 109 that is obtained by adding or deleting the mesh for the area enclosed by the fillet area shape data 107 and the contour of the targeted analysis mesh model 103 specified by the mesh specification section 102. The mesh display section 110 displays the filleted mesh model 109 on the input/output device 101.

In the first embodiment, the fillet information input section 104 selects a fillet face to be deleted from the targeted analysis mesh model 103 and stores the face as the fillet information data 105. Based on the fillet information data 105, the fillet area shape generation section 106 generates the fillet area shape data 107 from the fillet face and a face generated by extending an adjacent element face of the fillet face. The fillet mesh addition/deletion section 108 generates an unfilleted mesh model 109 that is obtained by adding or deleting the mesh for the area enclosed by the fillet area shape data 107 and the contour of the targeted analysis mesh model 103. The mesh display section 110 displays the unfilleted mesh model 109 on the input/output device 101.

When a convex edge portion is selected to be filleted, the fillet mesh addition/deletion section 108 generates the filleted mesh model 109 by deleting the meshes in the area surrounded by the contour of the targeted analysis mesh model 103 and the fillet area shape data 107.

When a concave edge portion is selected to be filleted, the fillet mesh addition/deletion section 108 generates the filleted mesh model 109 by adding the meshes in the, area surrounded by the contour of the targeted analysis mesh model 103 and the fillet area shape data 107.

When a convex face portion is selected to be unfilleted, the fillet mesh addition/deletion section 108 generates the filleted mesh model 109 by adding the meshes in the area surrounded by the contour of the targeted analysis mesh model 103 and the fillet area shape data 107.

When a concave face portion is selected to be unfilleted, the fillet mesh addition/deletion section 108 generates the filleted mesh model 109 by deleting the meshes in the area surrounded by the contour of the targeted analysis mesh model 103 and the fillet area shape data 107.

The fillet information input section 104 specifies the number of divisions (division count) in a circumferential direction of the fillet, and stores the division count as the fillet information data 105. The fillet area shape generation section 106 divides the fillet face in the fillet area shape data 107 based on the division count.

The fillet information input section 104 specifies a threshold value for an edge extraction angle, extracts an element edge group, and selects the element edge group as an edge to be filleted. The element edge group includes element edges belonging to two adjacent exterior surface element faces that form a normal vector angle greater than or equal to the threshold value.

The fillet information input section 104 recognizes characteristics of the targeted analysis mesh model 103, and selects a boundary edge between characteristics as an edge to be filleted.

The fillet information input section 104 recognizes characteristics of the targeted analysis mesh model 103, and selects a fillet face for deleting characteristics.

The following describes an example of the processes according to the first embodiment.

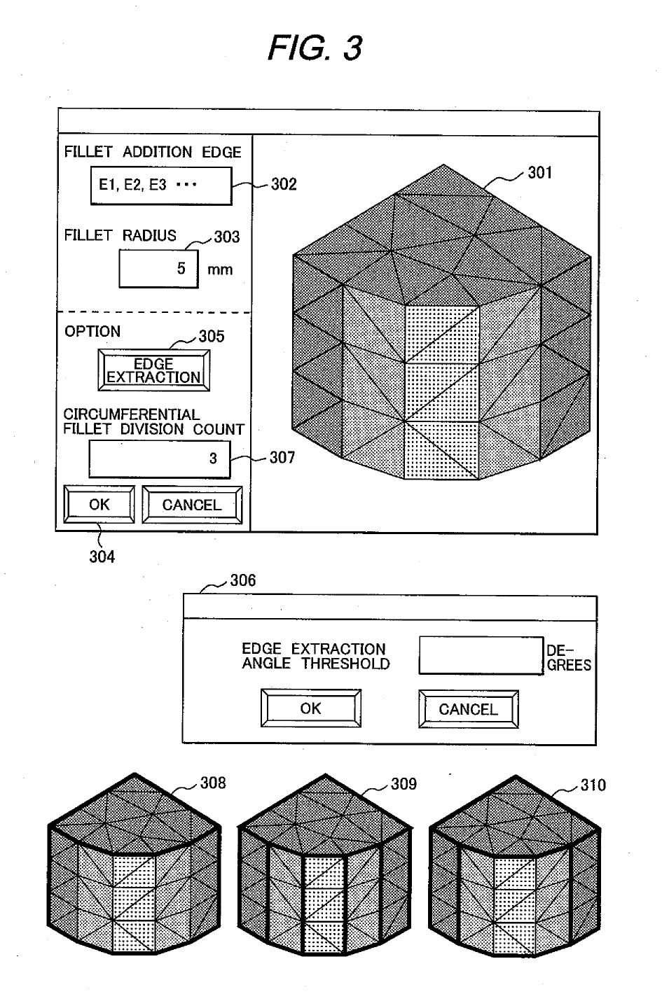

With reference to FIG. 2, the processes of the targeted analysis mesh specification section 102 will be explained. An apparatus user uses the input/output device 101 to enter a file name of the targeted analysis mesh model 103 in an analysis mesh model input field 201 displayed in the input/output device in FIG. 2. A press of an OK button 202 leads to an input of the file corresponding to the file name entered in the analysis mesh model input field 201 as the analysis mesh model 103. A press of a cancel button 203 leads to a cancel of the specification of the file name.

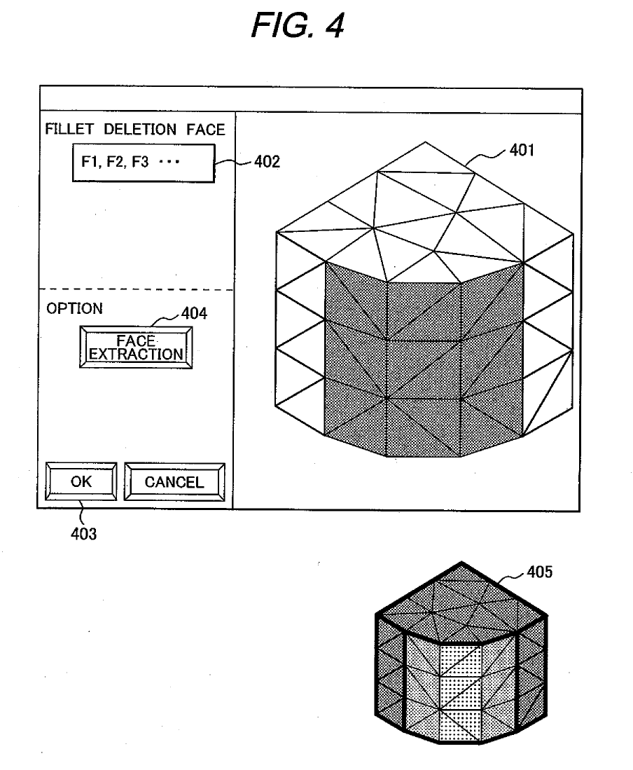

With reference to FIG. 3, an example of adding a fillet by using the fillet information input section 104 will be described. The apparatus user uses the input/output device 101 to select edges to be filleted from an analysis mesh model display screen 301 displayed in the input/output device in FIG.

3. The selected edges are displayed in a fillet addition edge field 302 and are highlighted on the display screen 301. The apparatus user enters a fillet radius in a fillet radius input field 303. Generally, a radius is specified for each fillet and may be replaced by a diameter. A press of an OK button 304 leads to storing of both data entered in the fillet addition edge field 302 and the fillet radius input field 303 as the fillet information data 105. When a fillet addition edge is specified, a press of an edge extraction button 305 leads to a display of a screen 306 so as to enter a threshold value for an edge extraction angle between normal vectors for adjacent meshes. Based on the entered value, the fillet information input section 104 extracts element edges from the targeted analysis mesh model 103 so that the element edges belong to two exterior surface element faces forming a normal vector angle greater than or equal to the threshold value. The extracted element edges may be highlighted so as to be selected as edges to be filleted. For example, if the edge extraction angle of 30 degrees is specified as the threshold value for the mesh model displayed on the analysis mesh model display screen 301, the fillet information input section 104 extracts edges represented by thick lines 308. If the angle of 10 degrees is specified, the fillet information input section 104 extracts edges represented by thick lines 309. Further, it is possible, at the time when the edge extraction button 305 is pressed, to recognize characteristics of the targeted analysis mesh model 103, highlight a boundary edge between the characteristics, and select edges to be filleted. For example, when the fillet information input section 104 recognizes characteristics of the analysis mesh model displayed on the analysis mesh model display screen 301 to extract a boundary edge between the characteristics, the fillet information input section 104 extracts edges represented by thick lines 310. Further, a circumferential fillet division count input field 307 may be used to enter a division count in a circumferential direction of the fillet. Then, a press of an OK button 364 leads to storing of the fillet information data 105 that includes the data entered into the circumferential fillet division count input field 307 as well as the fillet addition edge field 302 and the fillet radius input field 303. When a fillet is added, specifying a division count in the circumferential direction of the fillet makes it possible to control the fillet mesh density.

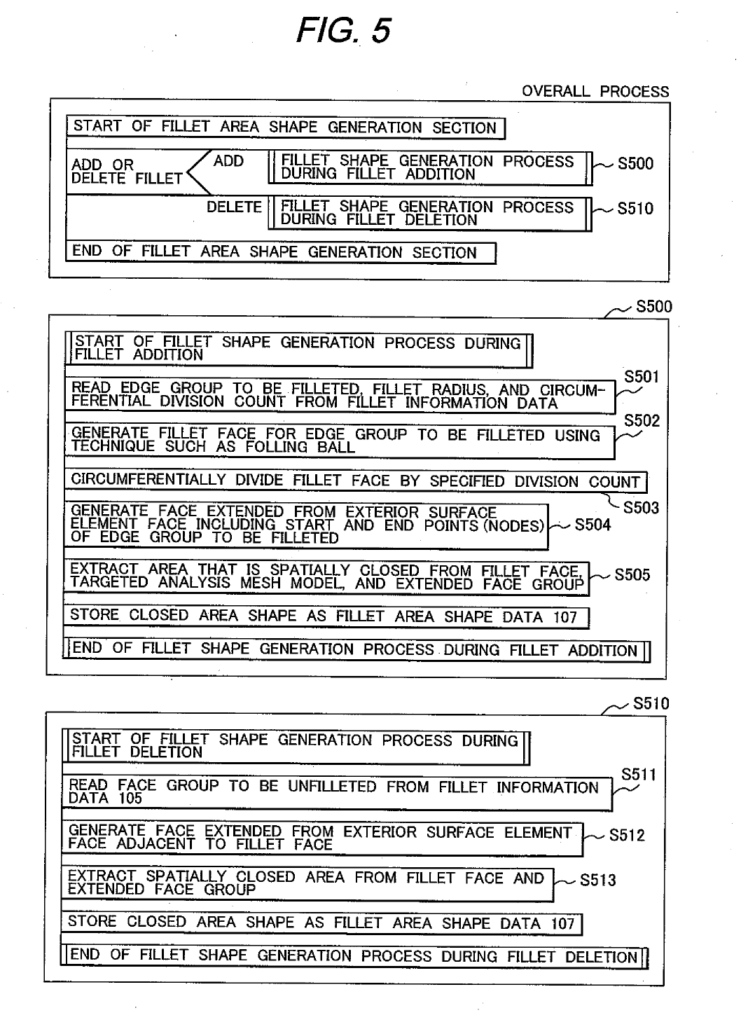

With reference to FIG. 4, an example of deleting a fillet by using the fillet information input section 104 will be described. The apparatus user uses the input/output device 101 to select element faces for fillets to be deleted from the analysis mesh model display screen 401 displayed in the input/output device in FIG. 4. The selected element faces are displayed in a fillet deletion face field 402 and highlighted on the display screen 401. When an OK button 403 is pressed, the data entered into the fillet deletion face field 402 is stored as the fillet information data 105. When a face extraction button 404 is pressed, the fillet information input section 104 may recognize characteristics of the targeted analysis mesh model 103 and select the characteristics as a fillet face to be deleted. For example, when the fillet information input section 104 recognizes characteristics of the analysis mesh model displayed on the analysis mesh model display screen 401, the analysis mesh model is classified into characteristics having edges as boundaries represented by thick lines 405.

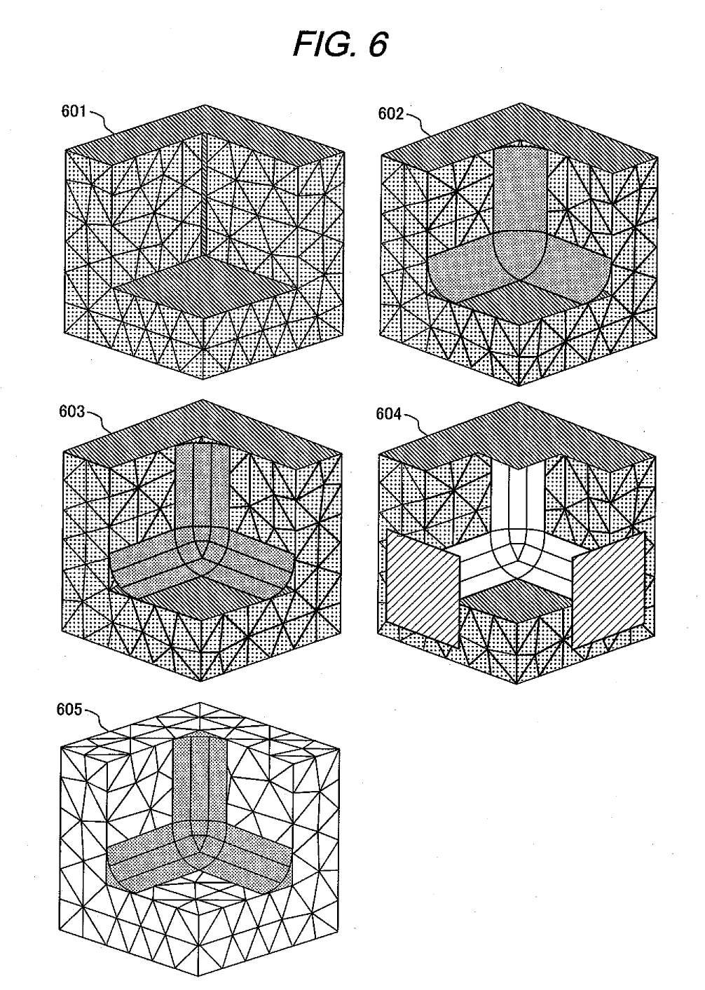

FIG. 5 shows examples of PAD (Problem Analysis Diagram) for processes of the fillet area shape generation section 106. The fillet area shape generation section 106 provides two types of processes depending on whether a fillet is added or deleted, as will be described below.

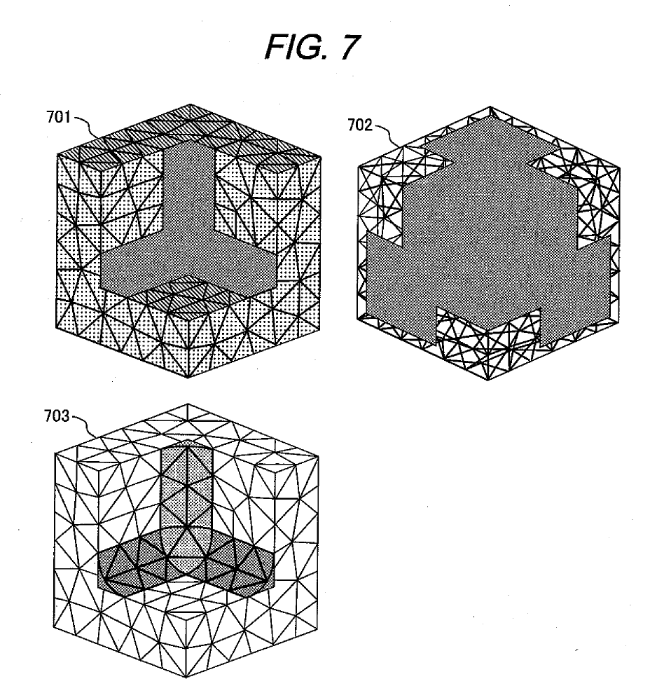

With reference to FIG. 6, a process of the fillet area shape generation section 106 (S500 in FIG. 5) will be described in the case when a fillet is added. The fillet area shape generation section 106 reads edge group to be filleted, a fillet radius, and a circumferential division count from the fillet information data 105 (S501 in FIG. 5). The graphic 601 in FIG. 6 shows emphasized edges to be filleted. The fillet area shape generation section 106 generates a fillet face (S502 in FIG. 5) for the edges by using a technique, such as Rolling Ball. The graphic 602 in FIG. 6 shows the generated fillet face. If the circumferential division count is specified, the fillet area shape generation section 106 divides the fillet face by the specified division count (S503 in FIG. 5). The graphic 603 in FIG. 6 shows the divided fillet faces. Then, the fillet area shape generation section 106 generates a face by extending the exterior surface element face that includes the beginning and end points (nodes) of the edge group to be filleted (S504 in FIG. 5). The graphic 604 in FIG. 6 shows the extended face group. The fillet area shape generation section 106 extracts a spatially closed area from the fillet face, the targeted analysis mesh model 103, and the extended face group (S505 in FIG. 5). The graphic 605 in FIG. 6 shows the extracted closed area shape. The extracted closed area shape is stored as the fillet area shape data 107.

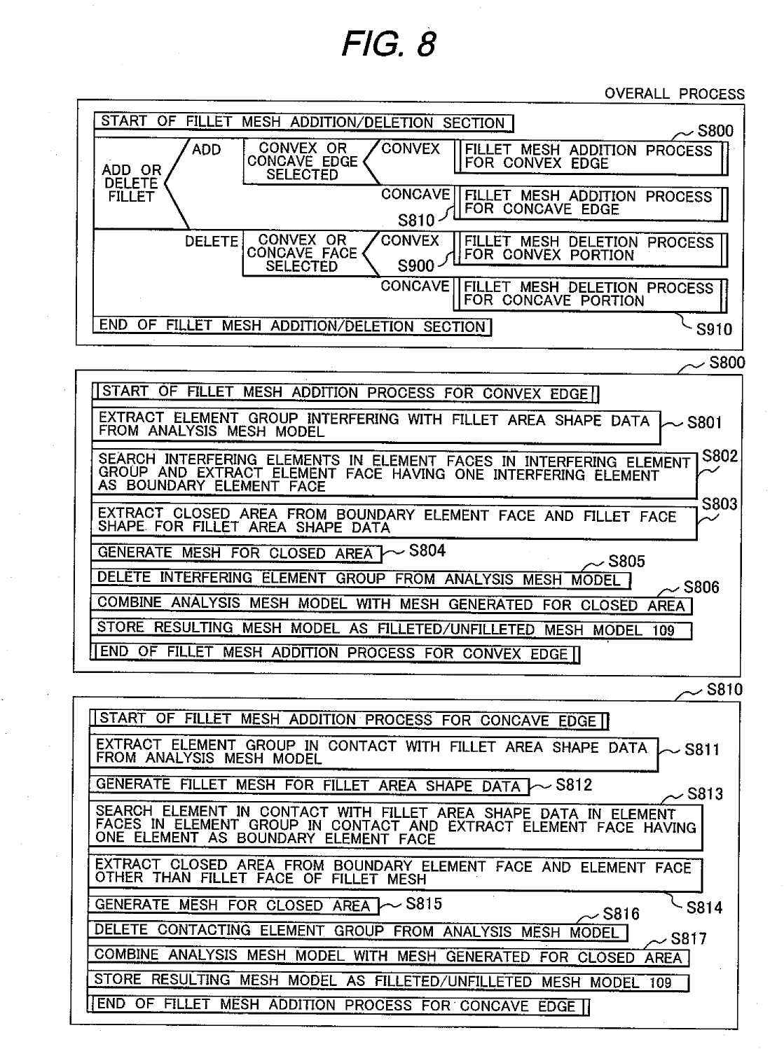

With reference to FIG. 7, a process of the fillet area shape generation section 106 (S510 in FIG. 5) will be described in the case when a fillet is deleted. The fillet area shape generation section 106 reads face group to be unfilleted from the fillet information data 105 (S511 in FIG. 5). The graphic 701 in FIG. 7 shows emphasized faces to be unfilleted. The fillet area shape generation section 106 generates a face by extending the exterior surface element face adjacent to the fillet face (S512 in FIG. 5). The graphic 702 in FIG. 7 shows the extended face group. Then, the fillet area shape generation section 106 extracts a spatially closed area from the fillet face and the extended face group (5513 in FIG. 5). The graphic 703 in FIG. 7 shows the closed area shape. The closed area shape is stored as the fillet area shape data 107.

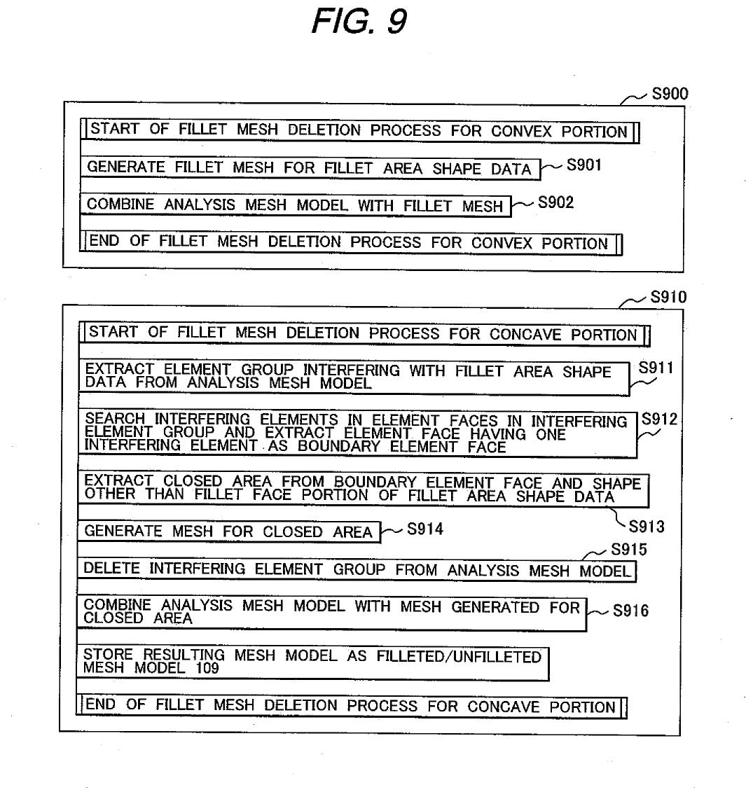

FIGS. 8 and 9 show examples of PADs for processes of the fillet mesh addition/deletion section 108. The fillet mesh addition/deletion section 108 provides four types of processes depending on whether a fillet is added or deleted or whether a portion to be added or deleted is concave or convex, as will described below. Two-dimensional sectional views are used in the examples for brief explanation.

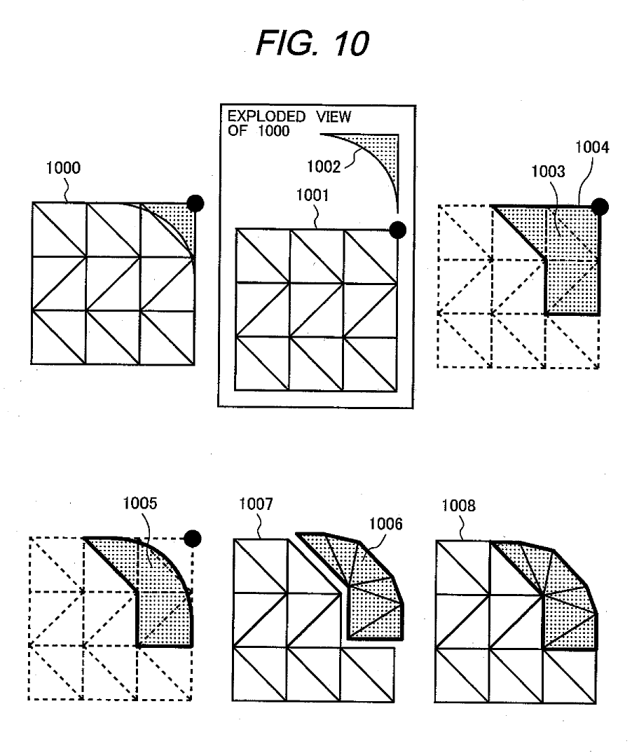

With reference to FIG. 10, processes of the fillet mesh addition/deletion section 108 will be described in the case when a convex edge is filleted (S800 in FIG. 8).

The fillet mesh addition/deletion section 108 extracts element group interfering with the fillet area shape data from the analysis meshmodel (S801 in FIG. 8). In FIG. 10, the graphic 1001 shows the analysis mesh model. The graphic 1002 shows the fillet area shape data. The graphic 1003 shows the interfering element group. The fillet mesh addition/deletion section 108 searches interfering elements in the element faces in the interfering element group and extracts an element face that has one interfering element as a boundary element face (S802 in FIG. 8). The graphic 1004 in FIG. 10 shows the extracted boundary element face. The fillet mesh addition/deletion section 108 extracts a closed area from the boundary element face and a fillet face shape for the fillet area shape data 107 (S803 in FIG. 8). The graphic 1005 in FIG. 10 shows, the extracted closed area. The fillet mesh addition/deletion section 108 generates a mesh for the closed area (S804 in FIG. 8) as shown by the graphic 1006 in FIG. 10. The fillet mesh addition/deletion section 108 deletes the interfering element group from the analysis mesh model (S805 in FIG. 8) as shown by the graphic 1007 in FIG. 10. The fillet mesh addition/deletion section 108 combines the analysis mesh model with the mesh generated for the closed area (S806 in FIG. 8). The resulting mesh model is stored as a filleted/unfilleted mesh model 109. The graphic 1008 in FIG. 10 shows a filleted mesh model. Consequently, filleted meshes can be generated for a convex edge. The process is applied only to the element interfering with the fillet. Therefore, nothing affects the meshes of the elements independent of the fillet, ensuring a high-speed process.

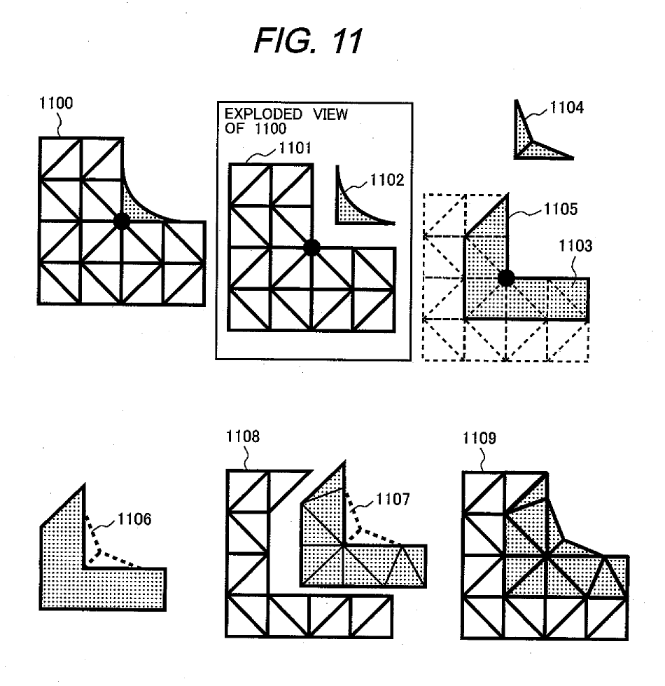

With reference to FIG. 11, processes of the fillet mesh addition/deletion section 108 will be described in the case when a concave edge is filleted (S810 in FIG. 8).

The fillet mesh addition/deletion section 108 extracts element group in contact with the fillet area shape data from the analysis meshmodel (S811 in FIG. 8). In FIG. 11, the graphic 1101 shows the analysis mesh model. The graphic 1102 shows the fillet area shape data. The graphic 1103 shows the element group in contact with the fillet area shape data. The fillet mesh addition/deletion section 108 generates a fillet mesh for the fillet area shape data (S812 in FIG. 8). The graphic 1104 in FIG. 11 shows meshes generated for the fillet area shape data. The fillet mesh addition/deletion section 108 searches elements in contact with the fillet area shape data in the element faces in the element group in contact with the fillet area shape data. The fillet mesh addition/deletion section 108 extracts an element face that has one element in contact with the fillet area shape data as a boundary element face (S813 in FIG. 8). The graphic 1105 in FIG. 11 shows the extracted boundary element face. The fillet mesh addition/deletion section 108 extracts a closed area from the boundary element face and the element faces other than the fillet faces of the fillet meshes in contact with the fillet area shape data (S814 in FIG. 8). The graphic 1106 in FIG. 11 shows the extracted closed area. The fillet mesh addition/deletion section 108 generates meshes 1107 in FIG. 11 for the closed area (S815 in FIG. 8). The fillet mesh addition/deletion section 108 further deletes element group in contact with the fillet area shape data from the analysis mesh model (S816 in FIG. 8) as shown by the graphic 1108 in FIG. 11. The fillet mesh addition/deletion section 108 combines the analysis mesh model with the meshes generated for the closed area (S817 in FIG. 8). The resulting mesh model is stored as the filleted/unfilleted mesh model 109. The graphic 1109 in FIG. 11 shows a filleted mesh model. Consequently, filleted meshes can be generated for a concave edge. The process is applied only to the element in contact with the fillet. Therefore, nothing affects the meshes of the elements independent of the fillet, ensuring a high-speed process.

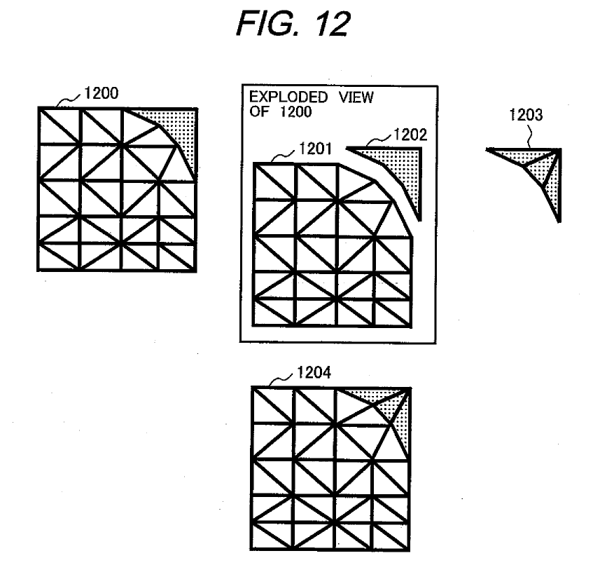

With reference to FIG. 12, processes of the fillet mesh addition/deletion section 108 will be described in the case when a convex portion is unfilleted (S900 in FIG. 9).

The fillet mesh addition/deletion section 108 generates a fillet mesh for the fillet area shape data 107 (S901 in FIG. 9). In FIG. 12, the graphic 1201 shows the analysis mesh model. The graphic 1202 shows the fillet area shape data. The graphic 1203 shows the meshes generated for the fillet shape data. The fillet mesh addition/deletion section 108 combines the analysis mesh model with the fillet mesh (S902 in FIG. 9). The resulting mesh model is stored as the filleted/unfilleted mesh model 109. The graphic 1204 in FIG. 12 shows the filleted mesh model. Thus, the meshes which the fillets in the convex portion are deleted from can be generated.

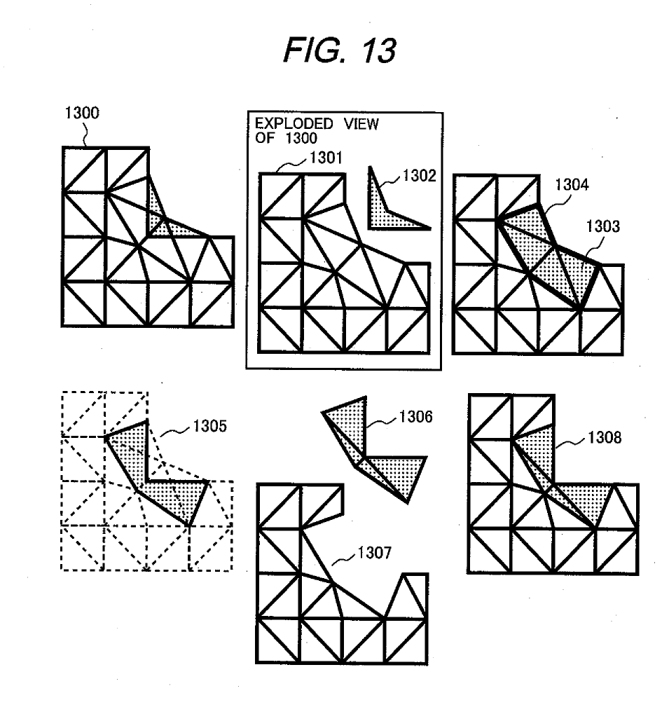

With reference to FIG. 13, processes of the fillet mesh addition/deletion section 108 will be described in the case when a concave portion is unfilleted (S910 in FIG. 9).

The fillet mesh addition/deletion section 108 extracts element group interfering with the fillet area shape data from the analysis mesh model (S911 in FIG. 9). In FIG. 13, the graphic 1301 shows the analysis mesh model. The graphic 1302 shows the fillet area shape data. The graphic 1303 shows the element group interfering with the fillet area shape data. The fillet mesh addition/deletion section 108 searches interfering elements in the element faces in the interfering element group and extracts an element face that has one interfering element as a boundary element face (S912 in FIG. 9). The graphic 1304 in FIG. 13 shows the extracted boundary element face. The fillet mesh addition/deletion section 108 extracts a closed area from the boundary element face and the shape other than the fillet faces of the fillet area shape data (S913 in FIG. 9). The graphic 1305 in FIG. 13 shows the extracted closed area. The fillet mesh addition/deletion section 108 generates meshes 1306 in FIG. 13 for the closed area (S914 in FIG. 9). The fillet mesh addition/deletion section 108 deletes interfering element group from the analysis mesh model 1301 (S915 in FIG. 9) as shown by the graphic 1307 in FIG. 13. The fillet mesh addition/deletion section 108 combines the analysis mesh model with the mesh generated for the closed area (S916 in FIG. 9). The resulting mesh model is stored as the filleted/unfilleted mesh model 109. The graphic 1308 in FIG. 13 shows the unfilleted mesh model. Consequently, the meshes which fillets in the concave portion are deleted from can be generated. The process is applied only to the element interfering with the fillet. Therefore, nothing affects the meshes of the elements independent of the fillet, ensuring a high-speed process.

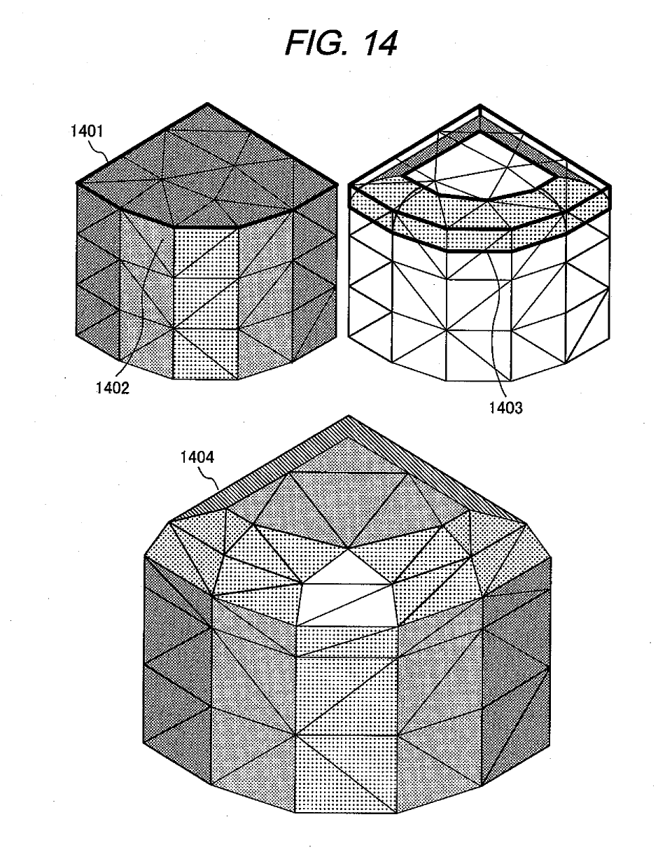

With reference to FIG. 14, the first example of usage procedure will be described for the analysis mesh generation apparatus of the present invention. A targeted analysis mesh model 1401 is shown in FIG. 14. This example describes an addition of a fillet to the analysis mesh model 1401 at the edge group indicated by thick lines 1402. The fillet has a radius of 5 mm and a circumferential division count of 2.

Using the screens displayed by the targeted analysis mesh specification section 102 and the fillet information input section 104, the apparatus user enters the radius of 5 mm and the circumferential division count of 2 as the targeted analysis mesh model and the fillet information at the edges indicated by thick lines 1402 in FIG. 14. The fillet area shape generation section 106 of the apparatus generates fillet shape data using the targeted analysis mesh model and the fillet information data. The generated fillet shape data 1403 is shown in FIG. 14. The fillet mesh addition/deletion section 108 of the apparatus generates a filleted mesh model using the targeted analysis mesh model and the fillet shape data. The filleted mesh model 1404 is shown in FIG. 14.

In this manner, a fillet can be directly added to the analysis mesh model and therefore the apparatus of the present invention can reduce the processes for the analysis model generation.

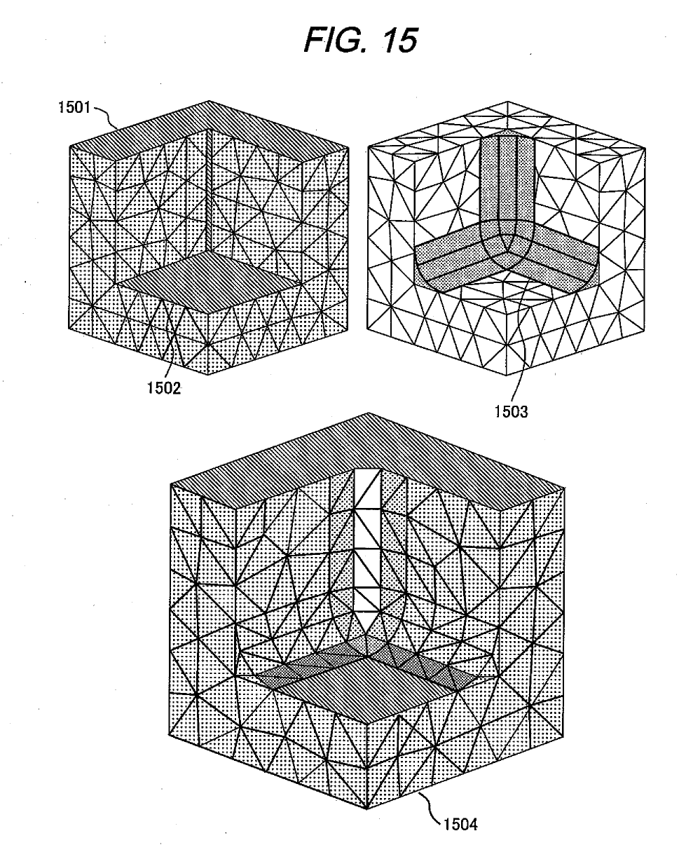

With reference to FIG. 15, the second example of usage procedure will be described for the analysis mesh generation apparatus of the present invention. A targeted analysis mesh model 1501 is shown in FIG. 15. This example describes an addition of a fillet to the analysis mesh model 1501 at the edge group indicated by thick lines 1502. The fillet has a radius of 5 mm and a circumferential division count of 3.

Using the screens displayed by the targeted analysis mesh specification section 102 and the fillet information input section 104, the apparatus user enters the radius of 5 mm and the circumferential division count of 3 as the targeted analysis mesh model and the fillet information at the edges indicated by thick lines 1502 in FIG. 15. The fillet area shape generation section 106 of the apparatus generates fillet shape data using the targeted analysis mesh model and the fillet information data. The generated fillet shape data 1503 is shown in FIG. 15. The fillet mesh addition/deletion section 108 of the apparatus generates a filleted mesh model using the targeted analysis mesh model and the fillet shape data. The filleted mesh model 1504 is shown in FIG. 15.

In this manner, a fillet can be directly added to the analysis mesh model and therefore the apparatus of the present invention can reduce the processes for the analysis model generation.

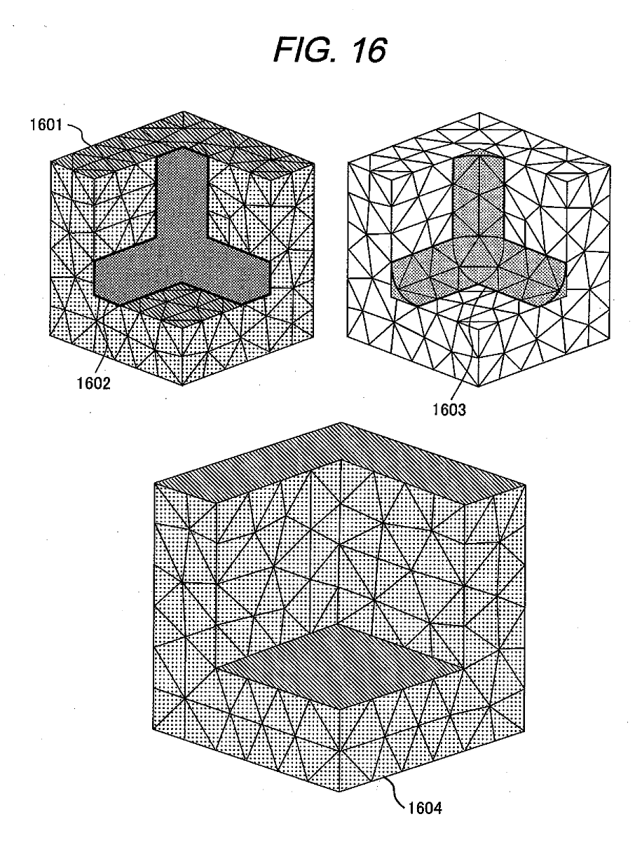

With reference to FIG. 16, the third example of usage procedure will be described for the analysis mesh generation apparatus of the present invention. A targeted analysis mesh model 1601 is shown in FIG. 16. This example describes a deletion of a fillet from the analysis mesh model 1601. The fillet is of the face group enclosed by thick lines 1602

Using the screens displayed by the targeted analysis mesh specification section 102 and the fillet information input section 104, the apparatus user enters the face group enclosed by thick lines 1602 as the targeted analysis mesh model and the fillet information in FIG. 16. The fillet area shape generation section 106 of the apparatus generates fillet shape data using the targeted analysis mesh model and the fillet information data. The generated fillet shape data 1603 is shown in FIG. 16. The fillet mesh addition/deletion section 108 of the apparatus generates an unfilleted mesh model using the targeted analysis mesh model and the fillet shape data. The unfilleted mesh model 1604 is shown in FIG. 16.

In this manner, a fillet can be directly deleted from the analysis mesh model and therefore the apparatus of the present invention can reduce the processes for the analysis model generation.

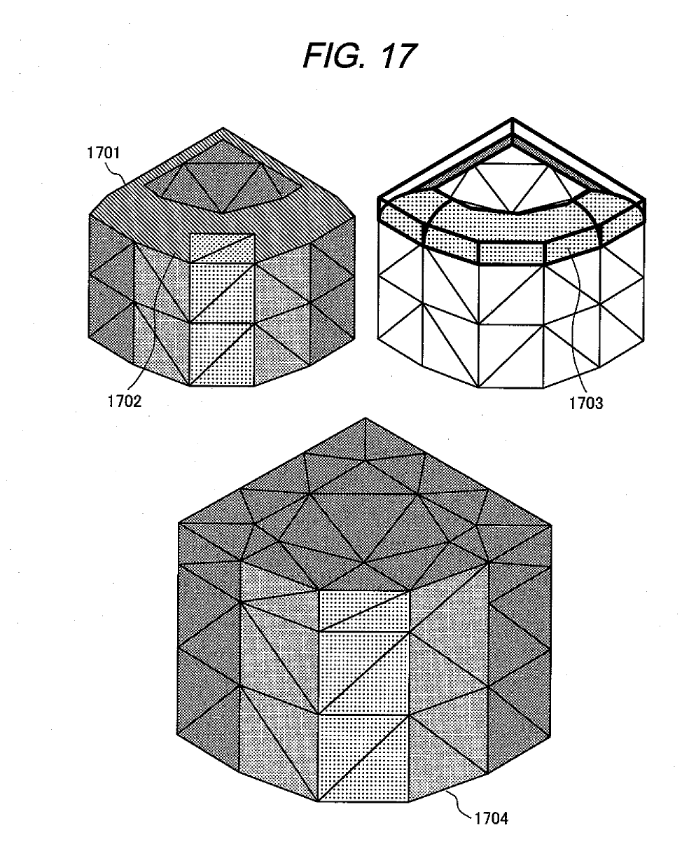

With reference to FIG. 17, the forth example of usage procedure will be described for the analysis mesh generation apparatus of the present invention. A targeted analysis mesh model 1701 is shown in FIG. 17. This example describes a deletion of a fillet of the hatched face group 1702 from the analysis mesh model 1701.

Using the screens displayed by the targeted analysis mesh specification section 102 and the fillet information input section 104, the apparatus user enters the hatched face group 1702 as the targeted analysis mesh model and the fillet information in FIG. 17. The fillet area shape generation section 106 of the apparatus generates fillet shape data using the targeted analysis mesh model and the fillet information data. The generated fillet shape data 1703 is shown in FIG. 17. The fillet mesh addition/deletion section 108 of the apparatus generates an unfilleted mesh model using the targeted analysis mesh model and the fillet shape data. The unfilleted mesh model 1704 is shown in FIG. 17.

In this manner, a fillet can be directly deleted from the analysis mesh model and therefore the apparatus of the present invention can reduce the processes for the analysis model generation.

What is claimed is:

1. An analysis mesh generation apparatus comprising a computer for generating a mesh model,
wherein the apparatus is configured to create a screen for selecting an edge of a mesh model and entering a radius of a fillet to be applied to the selected edge; and to create a screen for generating a mesh for the applied fillet, generating a new mesh model by deleting or adding an area enclosed by a contour of the mesh model and the fillet, and displaying the new mesh model.

2. An analysis mesh generation apparatus comprising a computer for generating a mesh model,
wherein the apparatus is configured to create a screen for specifying a mesh model; to create a screen for selecting an edge for a fillet to be applied in the specified mesh model; to create a screen for entering a radius of the fillet; and to create a screen for generating a fillet face based on the radius of the fillet, generating a fillet area shape from the fillet face and a face generated by extending an element face adjacent to the edge, generating a new mesh model by deleting or adding a mesh for an area enclosed by the fillet area shape on a contour of the mesh model, and displaying the new mesh model.

3. The analysis mesh generation apparatus according to claim 2,
wherein, if the edge is convex, the new mesh model is generated by deleting the mesh for the area enclosed by the contour of the mesh model and the fillet area shape.

4. The analysis mesh generation apparatus according to claim 2,
wherein, if the edge is concave, the new mesh model is generated by adding the mesh for the area enclosed by the contour of the mesh model and the fillet area shape.

5. The analysis mesh generation apparatus according to claim 2,
wherein the apparatus is configured to further create a screen for specifying a division count for dividing the fillet face in a circumferential direction of the fillet; and to create a screen for displaying the new mesh model that is obtained by dividing the fillet face in the fillet area shape by the division count.

6. The analysis mesh generation apparatus according to claim 2,
wherein the apparatus is configured to further create a screen for specifying a threshold value for an edge extraction angle between normal lines of adjacent meshes; to create a screen for extracting an edge group that has the edge extraction angle greater than or equal to the threshold value, and displaying the new mesh model that is obtained by adding the extracted edge group to the mesh model; and to create a screen for selecting the edge group that is added to the mesh model.

7. The analysis mesh generation apparatus according to claim 2,
wherein the apparatus is configured to further create a screen for recognizing characteristics of the mesh model for edge extraction; to create a screen for displaying the new mesh model that is obtained by adding a boundary between the characteristics to the mesh model which the characteristics is recognized of; and to create a screen for selecting the boundary between the characteristics in the new mesh model.

8. An analysis mesh generation apparatus comprising a computer for generating a mesh model,
wherein the apparatus is configured to create a screen for specifying a mesh model; to create a screen for selecting a fillet face to be deleted from the mesh model; and to create a screen for generating a fillet area shape from the fillet face and a face generated by extending an element face adjacent to the fillet face, generating a new mesh model by deleting or adding a mesh for an area enclosed by the fillet area shape on a contour of the mesh model, and displaying the new mesh model.

9. The analysis mesh generation apparatus according to claim 8,
wherein, if the fillet face is convex, the new mesh model is generated by adding the mesh for the area enclosed by the contour of the mesh model and the fillet area shape.

10. The analysis mesh generation apparatus according to claim 8,
wherein, if the fillet face is concave, the new mesh model is generated by deleting the mesh for the area enclosed by the contour of the mesh model and the fillet area shape.

11. The analysis mesh generation apparatus according to claim 8,
wherein the apparatus is configured to further create a screen for recognizing characteristics of the mesh model for edge extraction; to create a screen for displaying the new mesh model that is obtained by adding a boundary between the characteristics to the mesh model which the characteristics is recognized of; and to create a screen for selecting and deleting the boundary between the characteristics in the new mesh model.
